(19) United States
(12) Patent Application Publication
(10) Pub. No.: US 2007/0141979 A1
(43) Pub. Date: Jun. 21, 2007

(54) Automatic frequency changing modulator

(76) Inventor: Thomas A. Brey, Lake in the Hills, IL (US)

Correspondence Address: MOTOROLA, INC., 1303 EAST ALGONQUIN ROAD, IL01/3RD, SCHAUMBURG, IL, 60196, US

(21) Appl. No.: 11/312,274

(22) Filed: Dec. 20, 2005

(51) Int. Cl. H04H 7/00

(52) U.S. Cl. 455/3.06

(57) ABSTRACT

Disclosed herein is an automatic frequency changing modulator system that determines the frequency to which a destination radio is currently tuned, sets itself to that frequency, and transmits an audio signal to a user listening to that frequency. The automatic frequency changing modulator system includes a microphone and a radio receiver that are employed in conjunction with a digital signal processor to compare the audio being played back by the destination radio to the signals currently being broadcast. A match between the sampled audio and a broadcast signal determines the frequency to which the destination radio is tuned, and thus determines the frequency on which the automatic frequency changing modulator will transmit. Such a modulator system may advantageously be employed in hands free systems for mobile telephones or to provide other audio inputs in a car, for example, audio prompts from a navigation system.

### FIELD OF THE INVENTION

This invention relates to automotive electronics systems. More particularly, the invention relates to an automatic frequency changing modulator for providing an audio output signal to a car radio on the frequency to which the radio is already tuned.

### BACKGROUND

For many years, automobiles have come from the factory equipped with a variety of audio systems. At first, the audio systems were simple amplitude modulation (AM) radio receivers. With the proliferation of frequency modulated (FM) broadcast radio, FM radios also became common fixtures in cars. Today, it is not uncommon for a car radio to include a cassette player, a CD player, a CD changer, etc. Drivers, however, often have other devices that supply some form of audio output, e.g., a digital audio player (e.g., MP3 player), a cellular telephone, or a navigation system that provides audible prompts. It is desirable to use the speakers of the car audio system for communicating the audio output of these devices to the driver. Unfortunately, automobile audio systems often do not come equipped with auxiliary input jacks that allow these devices to be connected to the audio system.

In such cases, a modulator may be used to transmit audio to the radio that is now ubiquitous in automotive audio systems. Such devices are well known in the art, and have been used for a number of years. One example of such a modulator-based system is illustrated in FIG. 1, which depicts a typical hands free car system 100 for mobile telephones. The hands free system 100 uses an AM or FM modulator 101 to re-broadcast the audio from the telephone 105 onto the audio system of the car, which includes radio 103 and speakers 104. Audio from the telephone 105 is transmitted from the telephone to the hands free system 100 through a telephone interface 102. The interface 102 may communicate with the telephone in a variety of ways, including wireless links, such as IEEE 802.11 wireless networking or Bluetooth, or wired links.

One disadvantage to such a system is that it typically requires the user to dedicate one of the car radio preset buttons to answering phone calls. Specifically, the button is assigned to a frequency unused by a broadcast radio station, which can then be used by the modulator 101. When an incoming call is received, the user activates the preset button to tune the radio to the frequency used by the modulator 101. The user must also answer the call, typically by pressing another button on either the telephone 105 or the hands free system 100. Thus, most of these systems require that two buttons be actuated to answer a call.

The above scenario illustrates a known difficulty with the use of modulator based audio device interfaces, namely that the interface frequently becomes more cumbersome than necessary, resulting in user disappointment with the interface. Furthermore, this arrangement also presents a distraction to the driver, who often performs the multiple button presses while operating the vehicle. Yet another disadvantage of these arrangements is that one of a limited number of radio station preset buttons is allocated to use of the telephone, reducing the number of preset buttons available to the user for tuning in desired radio stations.

Therefore, what is needed in the art is a hands free system that can interface with an automobile radio through modulation, while eliminating the need for allocating a radio preset button to the modulator frequency.

### BRIEF DESCRIPTION OF THE DRAWINGS

Embodiments of the inventive aspects of this disclosure will be best understood with reference to the following detailed description, when read in conjunction with the accompanying drawings, in which:

FIG. 1 (prior art) illustrates a modulator based hands free system for use of a mobile telephone in a car;

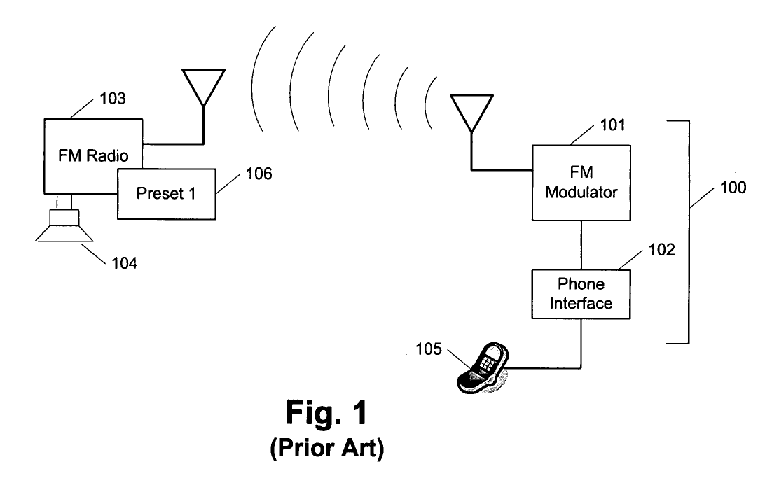

FIG. 2 illustrates a modulator based hands free system for use of a mobile telephone in a car in accordance with the present invention; and

FIG. 3 illustrates a method of operation of a modulator based hands free system for use of a mobile telephone in a car in accordance with the present invention.

### DETAILED DESCRIPTION

The present invention is directed to a modulator based interface for connecting an audio device to a automobile radio system. In one embodiment, the audio device is a mobile telephone, but the audio device may be any device that provides audio information to a user, such as an MP3 player or a navigation system that provides voice prompts. Advantageously, the modulator device does not require being preset to a particular frequency to which the automobile radio is subsequently tuned to receive audio. Rather the modulator is able to determine the frequency to which the radio is currently being tuned and set itself to that frequency. When it is necessary to transmit other audio to the user, e.g., when a telephone call is received, the modulator transmits on the frequency to which the radio is tuned. Transmitting the other audio on the frequency to which the radio is tuned eliminates the need for the user to re-tune the radio to hear the other audio (e.g., the audio from the telephone call), and also frees up the radio preset button for assignment to a broadcast radio station. Additionally, transmitting the other audio on the frequency to which the radio is tuned minimizes driver distraction by reducing the amount of driver involvement required to go from listening to radio programming to listening to the audio from the auxiliary device.

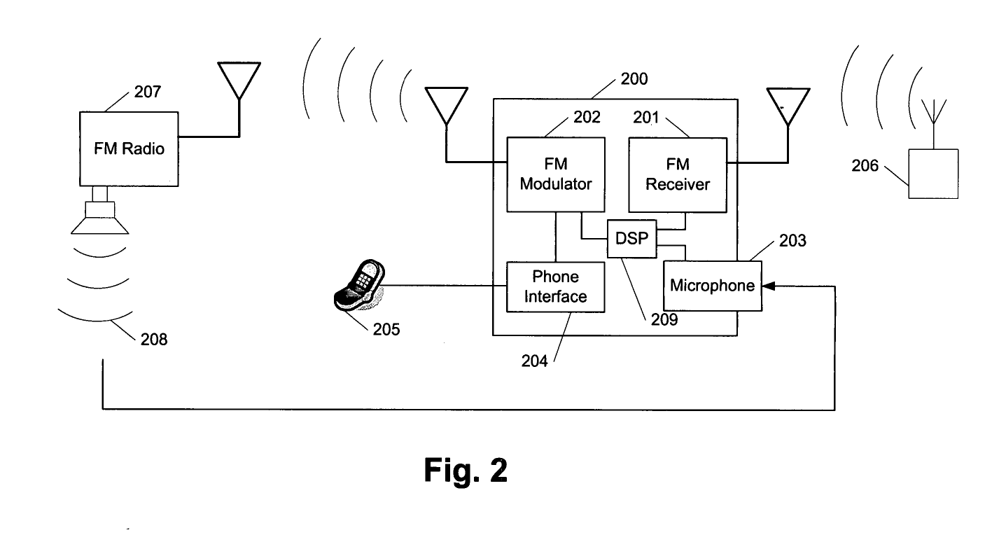

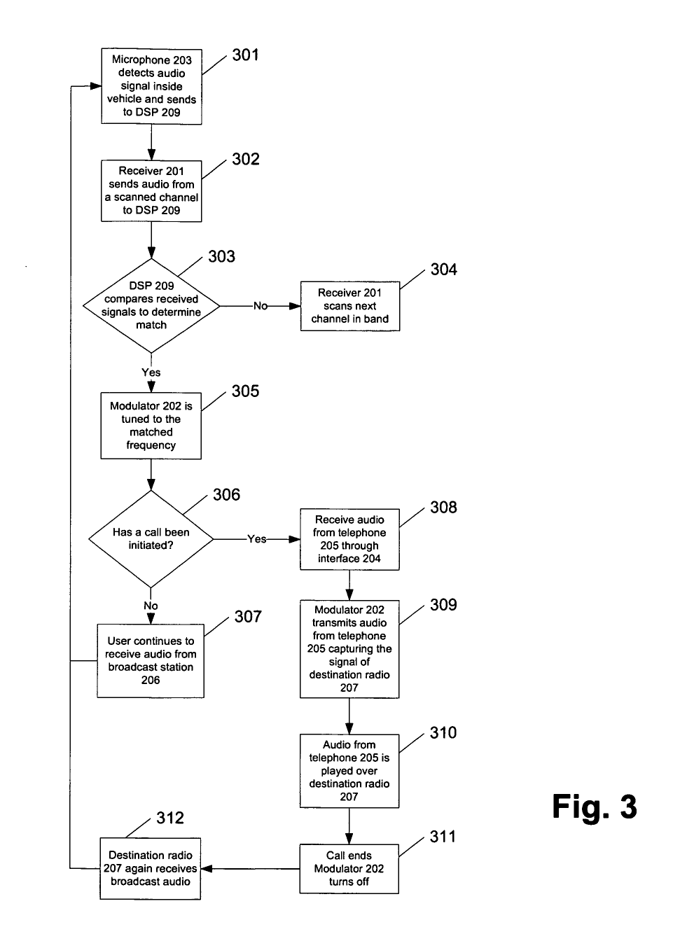

FIG. 2 illustrates an example of an automatic frequency changing modulator based hands free system 200 in accordance with the present invention. FIG. 3 illustrates operation of the hands free system 200. In the following description, reference numbers beginning with a “2” refer to FIG. 2, and reference numbers beginning with a “3” refer to FIG. 3. Hands free system 200 comprises its own scanning radio receiver 201. In the illustrated example, the scanning radio receiver 201 is a FM receiver, but an AM receiver could also be used. The hands free system 200 includes FM modulator 202 (an AM modulator could also be used), a microphone 203, and a phone interface 204. The phone interface 204 may be either a wired or wireless interface.

The hands-free system 200 is configured to use the scanning radio receiver 201 and the microphone 203 to determine which broadcast radio frequency 206 the user is listening to. In one embodiment, the hands-free system 200 may include both AM and FM receivers and modulators to accommodate whichever frequency band the user is listening to. The hands-free system 200 determines the broadcast channel to which the user is listening by sampling the sounds 208 in the automobile cabin using microphone 203 (step 301). The hands-free system 200 also causes scanning radio receiver 201 to scan through a broadcast band (step 302). The sampled sounds and the broadcast sounds are compared (step 303) to determine whether the scanning radio receiver 201 has found the frequency to which the destination radio 207 is tuned. If the station is not a match, the scanning radio receiver 201 scans to the next channel in the band (step 304). If a match is found, the modulator 202 is tuned to the matched frequency (step 305). By performing this scanning periodically, the hands-free system 200 detects when the user changes frequencies and determines the new frequency to which the user has tuned. Comparing the signal (step 303) on each frequency with the audio in the vehicle may be performed in a variety of ways known to those skilled in the art, for example, using a suitably programmed digital signal processor (DSP) 209.

Once a signal on a given frequency is matched with the audio in the vehicle, the hands-free system 200 tunes its own modulator 202 to the identified frequency (step 305) and waits until the hands-free system 200 is activated, for example, on receipt of an incoming phone call (step 306). Until a call is received, the user continues to receive audio from broadcast station 206 (step 307). When an incoming phone call is received, and the hands free system is activated (step 308), e.g., when the user actuates an answer button, the modulator 202 transmits the audio from the telephone 205 onto the channel to which the destination radio 207 (e.g., the radio in the vehicle) is already tuned (step 309). This results in the telephone audio being played over destination radio 207 (step 310).

The hands free system 200 also uses its scanning radio receiver 201 to determine the signal strength of the broadcast radio station 206 that the destination radio 207 is currently tuned-in. The system adjusts the power of its own modulator 202 to the required level needed to capture the channel that the destination radio 207 is currently receiving. Essentially, this adjustment overpowers the broadcast signal and forces the destination radio 207 to receive the broadcast from the hands-free system 200. When the call ends, the hands-free system's modulator 202 is turned off (step 311), which again allows the destination radio 207 to receive the broadcast signal (step 312).

When the user is initiating a call, the system operates in the same manner as described above. Specifically, when the user activates the phone, e.g., by pressing a TALK or SEND button on the handset or on the hands-free system 200, the hands-free system 200 tunes its modulator 202 to the frequency currently being listened to in the vehicle. As explained above, the hands-free system 200 continuously monitors the audio in the vehicle and scans the broadcast band(s) to match this audio to the signals it receives with its own scanning radio receiver 201. As in the case of an incoming call, the modulator 202 transmits the telephone audio onto the channel that the destination radio 207 is already tuned to and adjusts the power level as necessary to capture the channel. When the call is terminated, the modulator 202 is turned off, again allowing the destination radio 207 to receive the broadcast signal.

Thus, it is possible to have a modulator based interface for conveying audio from an auxiliary audio device to a destination radio (e.g., the built-in radio in a car) with a greatly simplified interface. Specifically, the system may be used without manual intervention from the user, thereby reducing driver distraction. Furthermore, the automatic frequency changing modulator described herein eliminates the need for a user to allocate a radio station preset button on the destination radio to the auxiliary audio device modulator interface, freeing this button up for use with preferred broadcast radio stations.

It should be understood that the inventive concepts disclosed herein are capable of many modifications, combinations and sub-combinations. For example, although disclosed in terms of hands free systems for mobile telephones, the system could also be used with other auxiliary audio devices, such as digital music players, navigation systems that provide audible prompts, etc. Additionally, although described in terms of a device integrated with a mobile telephone hands-free system, the modulator interface system could be a free standing device with a generic audio input or could be entirely built into a mobile telephone or other auxiliary audio device. To the extent such permutations fall within the scope of the appended claims and their equivalents, they are intended to be covered by this patent.

What is claimed is:

1. An automatic frequency changing modulator system for allowing audio from an auxiliary audio device to be played back by a destination radio, the modulator system comprising:
an interface configured to receive an audio signal from the auxiliary audio device;
a microphone configured to sample audio being played back by a destination radio;
a scanning radio receiver configured to receive broadcast radio signals;
a digital signal processor coupled to the microphone and the radio receiver, the digital signal processor being programmed to compare the received broadcast radio signals to the sampled audio to determine a frequency to which the destination radio is tuned; and
a modulator coupled to the interface and configured to transmit the audio signal from the auxiliary audio device to the destination radio on the frequency to which the destination radio is tuned.

2. The automatic frequency changing modulator system of claim 1 wherein the interface is a wireless interface.

3. The automatic frequency changing modulator system of claim 2 wherein the wireless interface is a Bluetooth interface.

4. The automatic frequency changing modulator system of claim 1 wherein the auxiliary audio device is a mobile telephone.

5. The automatic frequency changing modulator system of claim 1 wherein the auxiliary audio device is a navigation system providing audio prompts to a driver.

6. The automatic frequency changing modulator system of claim 1 wherein the auxiliary audio device is a digital music player.

7. The automatic frequency changing modulator system of claim 1 further comprising circuitry for determining the strength of the broadcast radio signals and setting a transmit power of the modulator accordingly.

8. The automatic frequency changing modulator system of claim 7 wherein the interface is a wireless interface.

9. The automatic frequency changing modulator system of claim 8 wherein the wireless interface is a Bluetooth interface.

10. A method of tuning an automatic frequency changing modulator for conveying audio information from an auxiliary audio device to a destination radio, wherein the destination radio is tuned to a particular broadcast frequency, the method comprising:
sampling sound played back by the destination radio;
scanning a broadcast radio band to identify one or more broadcast frequencies to which the destination radio may be tuned;
comparing the sampled sound to an audio signal from each of the one or more broadcast frequencies to determine the particular broadcast frequency to which the destination radio is tuned;
setting the modulator to the particular broadcast frequency.

11. The method of claim 10 further comprising:
determining a signal strength of the particular broadcast frequency to which the destination radio is tuned; and
setting a transmit power of the modulator accordingly.

12. A hands free system for conveying audio from a mobile telephone to a destination radio, wherein the hands free system comprises an automatic frequency changing modulator, the automatic frequency changing modulator comprising:
an interface configured to receive an audio signal from the mobile telephone;
a microphone configured sample audio being played back by the destination radio;
a radio receiver configured to receive broadcast radio signals from a band also received by the destination radio;
a digital signal processor coupled to the microphone and the radio receiver, the digital signal processor being programmed to compare the received broadcast radio signals to the sampled audio to determine a frequency to which the destination radio is tuned; and
a modulator coupled to the interface and configured to transmit the audio signal from the mobile telephone to the destination radio on the frequency to which the destination radio is tuned.

13. The hands free system of claim 12 wherein the interface is a wireless interface.

14. The hands free system of claim 13 wherein the wireless interface is a Bluetooth interface.

15. The hands free system of claim 12 further comprising circuitry coupled to the radio receiver for determining the strength of the broadcast radio signals and coupled to the modulator and configured to set a transmit power of the modulator accordingly.

16. The hands free system of claim 15 wherein the interface is a wireless interface.

17. The hands free system of claim 16 wherein the wireless interface is a Bluetooth interface.

18. An auxiliary audio device comprising an automatic frequency changing modulator interface, the automatic frequency changing modulator being configurable to convey audio from the auxiliary audio device to a destination radio, the automatic frequency changing modulator comprising:
a microphone configured sample audio being played back by the destination radio;
a radio receiver configured to receive broadcast radio signals from a band also received by the destination radio;
a digital signal processor coupled to the microphone and the radio receiver, the digital signal processor being programmed to compare the received broadcast radio signals to the sampled audio to determine a frequency to which the destination radio is tuned; and
a modulator configured to transmit audio to the destination radio on the frequency to which the destination radio is tuned.

19. The auxiliary audio device of claim 18 wherein the auxiliary audio device is one of the following: a mobile telephone, a navigation system providing audio prompts to a driver, or a digital music player.
